(19) United States
(12) Patent Application Publication
(10) Pub. No.: US 2022/0198637 A1
(43) Pub. Date: Jun. 23, 2022

(54) INSPECTION DEVICE

(71) Applicant: DENSO CORPORATION, Kariya-city (JP)

(72) Inventors: Kazue ASANO, Kariya-city (JP); Motohiro SHIRAI, Kariya-city (JP)

(21) Appl. No.: 17/690,385

(22) Filed: Mar. 9, 2022

Related U.S. Application Data
(63) Continuation of application No. PCT/JP2020/034757, filed on Sep. 14, 2020.

(30) Foreign Application Priority Data
Oct. 9, 2019 (JP) 2019-186082

(51) Int. Cl. G06T 7/00

(52) U.S. Cl. CPC G06T 7/001; G06T 2207/10016

(57) ABSTRACT

An inspection device includes an imaging device and a determinator. The imaging device is attached to an operator to image an imaging range, and the determinator is configured to determine a quality of an inspection object. The imaging device is configured to constantly image the imaging range and to sequentially transmit the image data of the imaging range to the determinator. The determinator determines the quality of the inspection object by collating an acquired image data of the inspection object, acquired from the image data transmitted from the imaging device, with a collation image data registered in advance.

### CROSS REFERENCE TO RELATED APPLICATION

The present application is a continuation application of International Patent Application No. PCT/JP2020/034757 filed on Sep. 14, 2020, which designated the U.S. and claims the benefit of priority from Japanese Patent Application No. 2019-186082 filed on Oct. 9, 2019. The entire disclosures of all of the above applications are incorporated herein by reference.

### TECHNICAL FIELD

The present disclosure relates to an inspection device used for inspecting an inspection object.

### BACKGROUND

An inspection device attached to an operator may include a code reader, a camera, and a tablet. The code reader reads a code indicating the type of work to be inspected. The camera takes an image of the work. A microcomputer of the tablet sends an imaging command to the camera in response to that the code reader reads the work code as a trigger. Based on this imaging command, the camera captures an image of the work and acquires the captured image. The microcomputer selects a reference image of the work corresponding to the code read by the code reader from among reference images of a plurality of types of works stored in advance in a memory, and compare the reference image and the captured image of the selected work with each other, so as to determine whether or not the selected work is a non-defective product (i.e., good product). However, in this case, it may be difficult to accurately determine a defective product or non-defective product.

### SUMMARY

An inspection device according to an aspect of the present disclosure is used for inspecting an inspection object, and includes an imaging device and a determinator. The imaging device is attached to an operator to image an imaging range. The determinator is configured to determine a quality of the inspection object, and the imaging device is configured to constantly image the imaging range and to sequentially transmit the image data of the imaging range to the determinator. The determinator determines the quality of the inspection object by collating an acquired image data of the inspection object, acquired from the image data transmitted from the imaging device, with a collation image data registered in advance. Therefore, workability of the inspection device can be improved.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram schematically showing a part of a manufacturing process of a first embodiment of the present disclosure;

FIG. 2 is a block diagram showing a configuration of an inspection device according to the first embodiment;

FIG. 3 is a flow diagram showing processing procedures executed respectively by a determinator of a terminal device and an imaging device according to the first embodiment;

FIG. 4 is a schematic diagram showing an example of collation image data of the first embodiment;

FIG. 5 is a flow diagram showing processing procedures executed respectively by a determinator of a terminal device and an imaging device according to a second embodiment of the present disclosure; and

FIGS. 6A, 6B, 6C are diagrams schematically showing a first non-defective product image data, a second non-defective product image data, and a third non-defective product image data, used for collation image data of a third embodiment of the present disclosure.

### DESCRIPTION OF EMBODIMENT

An inspection device that can be attached to an operator may include a code reader, a camera, and a tablet. In the inspection device, in order to capture an image of a collation work by the camera, it is necessary for the operator to read a code of a work by the code reader. In this case, workability of the inspection device is deteriorated.

As a method that does not use a code reader, for example, a method that uses a predetermined switch provided in a tablet, equipment, or the like may be considered. Specifically, the operator operates a photographing switch after setting the work at a predetermined position. The tablet sends an imaging command to the camera in response to the operator's operation of the photographing switch, so that the camera acquires a captured image of the work based on the imaging command. After that, the operator further operates an inspection switch, and a microcomputer of the tablet collates the image captured by the camera with a reference image to determine whether or not the work is a non-defective product (i.e., good product). However, when such a method is used, it is necessary for the operator to operate the photographing switch and the inspection switch. Therefore, in this case, workability is difficult to be improved.

An object of the present disclosure is to provide an inspection device capable of inspecting an inspection object and improving workability of an operator.

An inspection device according to an aspect of the present disclosure is used for inspecting an inspection object, and includes an imaging device and a determinator. The imaging device is attached to an operator to image an imaging range. The determinator is configured to determine a quality of the inspection object. The imaging device is configured to constantly image the imaging range and to sequentially transmit the image data of the imaging range to the determinator. The determinator determines the quality of the inspection object by collating an acquired image data of the inspection object, which can be acquired from the image data transmitted from the imaging device, with a collation image data registered in advance.

According to this configuration, the imaging range is constantly imaged by the imaging device, and the determinator determines the quality of the inspection object based on the acquired image data of the inspection object acquired from the image data of the imaging range. Therefore, it is unnecessary to have an operation that triggers an image of an inspection object to be inspected, an operation for starting collation of the inspection object, or the like. Therefore, workability of the inspection device can be improved.

For example, the determinator may be configured to collate the image data of the imaging device with the collation image data each time the image data is transmitted from the imaging device or at a predetermined cycle.

The determinator may be configured to include a plurality of non-defective product image data different from each other as the collation image data. In this case, the determinator may determine that the inspection object is a non-defective product when the image data transmitted from the imaging device respectively collate a plurality of non-defective product image data in a predetermined order. The determinator may be configured to include, as the collation image data, reference image data corresponding to a non-defective product of the inspection object and one or a plurality of related image data similar to the reference image data.

The determinator may be configured to determine that the inspection object is a defective product when a state in which the inspection object is determined not to be a non-defective product continues for a predetermined time.

Alternatively, the determinator may be configured to include collation image data corresponding to a non-defective product and collation image data corresponding to a defective product, as the collation image data. In this case, the determinator determines that the inspection object is a non-defective product based on that collation between the image data of the imaging device and the collation image data corresponding to the non-defective product is established, and determines that the inspection object is a defective product based on that collation between the image data of the imaging device and the collation image data corresponding to the defective product is established.

Hereinafter, an inspection device of the present disclosure will be described with reference to the drawings. In order to facilitate the understanding, the same reference numerals are attached to the same constituent elements in each drawing, and redundant explanations are omitted.

### First Embodiment

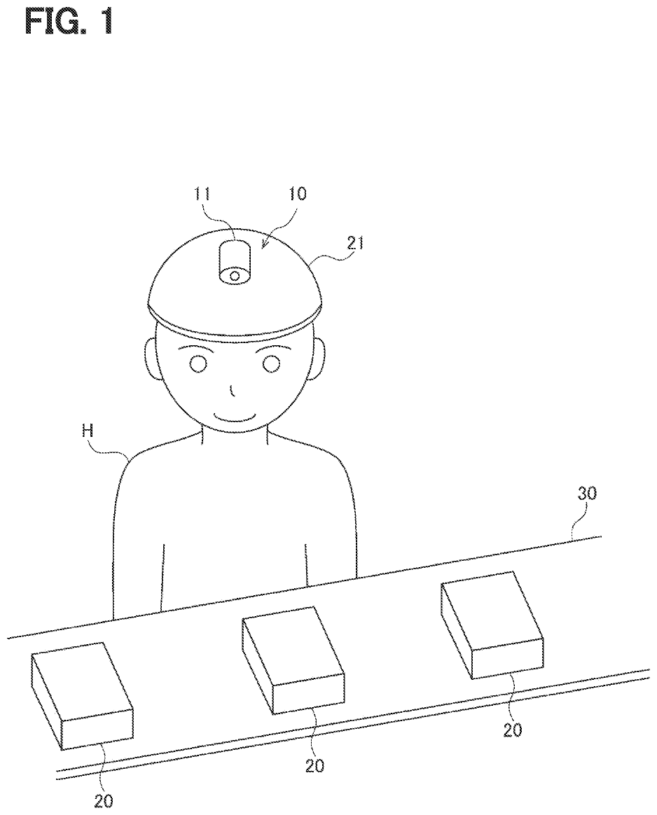

First, an inspection device 10 according to the first embodiment shown in FIG. 1 will be described. The inspection device 10 according to the first embodiment is used in a manufacturing process of a product such as a heat exchanger, an electrical device or the like. Specifically, the inspection device 1 is used in an intermediate manufacturing stage before a finished product, to inspect whether or not an inspection object such as a workpiece 20 is a good product (i.e., non-defective product). Specifically, the workpiece 20 is flowing on a production line while being placed on a conveyor 30. In the vicinity of the conveyor 30, a plurality of operators (e.g., workers) H are lined up along a flow direction of the workpiece 20. When the workpiece 20 is positioned in front of the worker H, the worker H performs an assembling work for assembling a predetermined part or predetermined plural parts at the position of the workpiece 20. At that time, the inspection device 10 inspects whether or not the workpiece 20, to which the predetermined part(s) is assembled, is a non-defective product (good product). The inspection device 10 is a wearable inspection device that can be worn by the worker H, for example. Each worker H sequentially performs the assembly work of predetermined parts so that a finished product is manufactured.

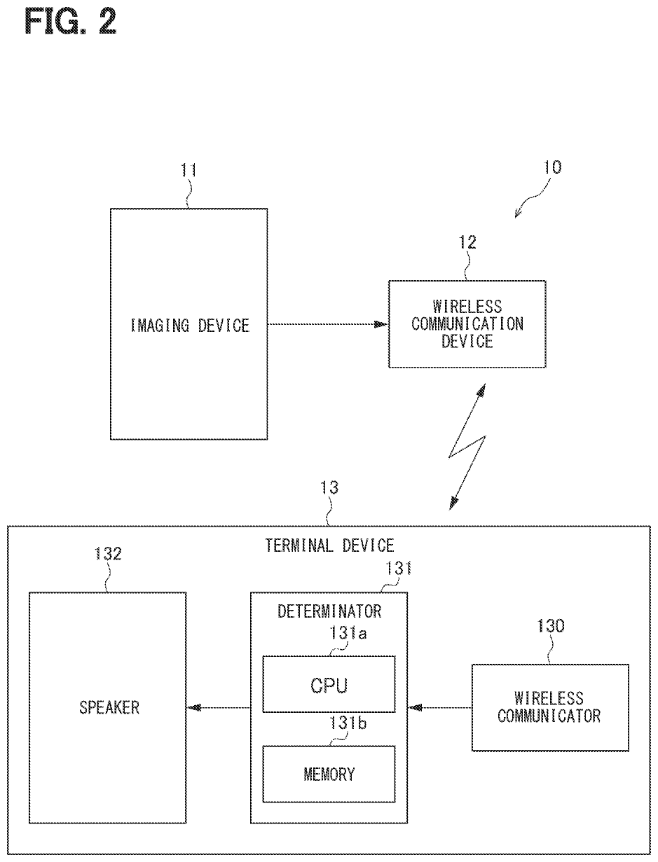

As shown in FIG. 2, the inspection device 10 includes an imaging device 11, a wireless communication device 12, and a terminal device 13. The wireless communication device 12 and the terminal device 13 are not shown in FIG. 1.

As shown in FIG. 1, the imaging device 11 is attached to the worker H to pickup an imaging range. The imaging device 11 is fixedly attached to a helmet 21 worn on the head of the worker H. The imaging range of the imaging device 11 is set to a predetermined range in the direction in which the face of the worker H is facing, that is, in front of the worker H. When the worker H turns his/her face toward the workpiece 20 in order to assemble a predetermined part to the workpiece 20, the entire workpiece 20 is positioned within the imaging range of the imaging device 11. The imaging device 11 constantly images the imaging range regardless of whether or not the workpiece 20 is present in the imaging range, and transmits the image data of the captured imaging range to the wireless communication device 12 shown in FIG. 2. In the present embodiment, the imaging device 11 is an example of an image pickup unit such as a camera, a radar or the like.

The wireless communication device 12 is connected to the imaging device 11 by a wire or a wireless communication. The wireless communication device 12 sequentially transmits the image data transmitted from the imaging device 11 to the terminal device 13 by wireless communication or the like.

The terminal device 13 is a portable tablet terminal, a stationary personal computer, or the like. The terminal device 13 determines the quality of the workpiece 20 based on the image data wirelessly transmitted from the imaging device 11 via the wireless communication device 12, and notifies the worker H of the determination result. The terminal device 13 includes a wireless communicator 130, a determinator 131, and a speaker 132.

The wireless communicator 130 receives the image data sequentially transmitted from the wireless communication device 12, and transmits the received image data to the determinator 131.

The determinator 131 is mainly configured by a microcomputer having a CPU 131a, a memory 131b, and the like. The determinator 131 is configured to perform a control program stored in the memory 131b. Specifically, the determinator 131 is configured to perform an image process for extracting an image data of the workpiece 20 from the image data in the imaging range by executing a program stored in advance in the memory 131b, and to perform a determination process for determining the quality of the workpiece 20 based on the extracted image data of the workpiece 20. The determinator 131 notifies the speaker 132 of the quality determination result of the workpiece 20 obtained through the determination process. Specifically, when the determinator 131 determines that the workpiece 20 is a non-defective product (good product), the determinator 131 outputs a first sound indicating the non-defective product from the speaker 132. When the determinator 131 determines that the workpiece 20 is a defective product (bad product), the determinator 131 outputs a second sound indicating the defective product from the speaker 132. The first sound and the second sound are different sounds.

Next, a specific procedure of processes executed by the imaging device 11 and the terminal device 13 will be described.

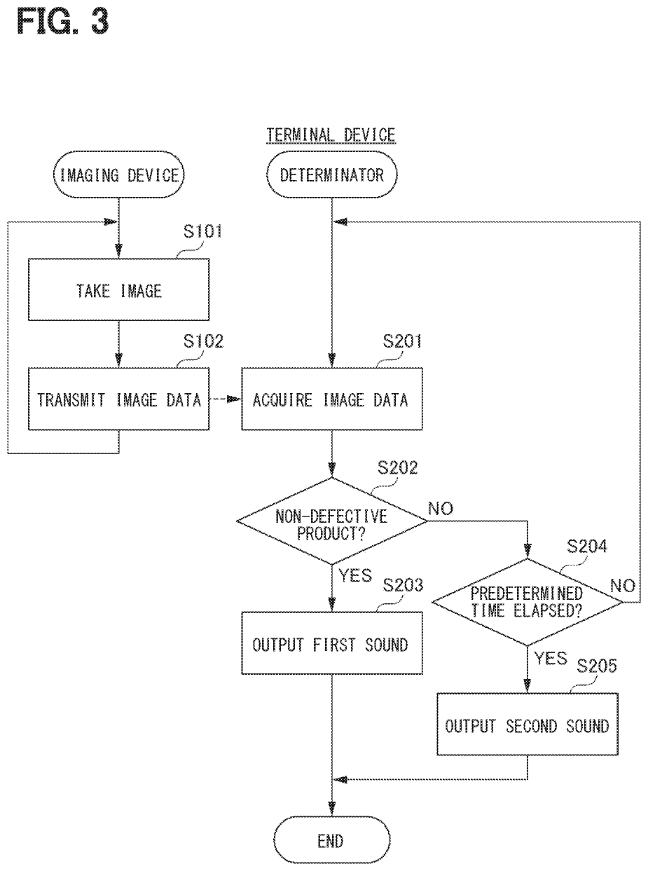

As shown in FIG. 3, the imaging device 11 images an imaging range in the process of step S101, and the image data of the imaging range is transmitted sequentially to the terminal device 13 via the wireless communication device 12 in the process of step S102. The imaging device 11 performs imaging and transmission of the image data at a predetermined cycle.

The determinator 131 of the terminal device 13 sequentially receives and acquires the image data of the imaging range transmitted from the imaging device 11 in the process of step S201. Hereinafter, the image data of the imaging range transmitted from the imaging device 11 to the terminal device 13 will be referred to as “image data of the imaging device 11”. As shown in FIG. 3, the determinator 131 determines whether or not the workpiece 20 is a non-defective product in the process of step S202, based on the image data of the imaging device 11.

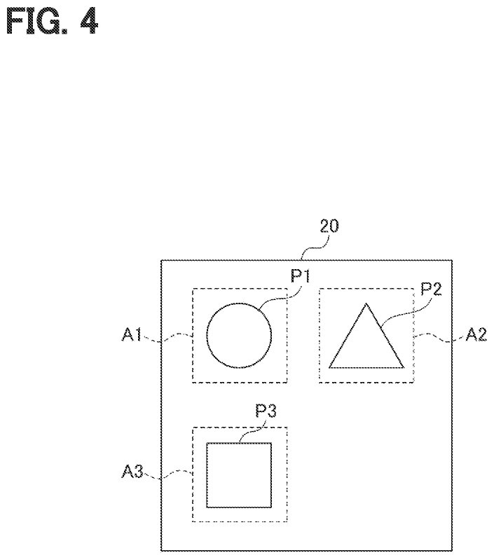

Specifically, in the process of step S202, the determinator 131 extracts the image data of the workpiece 20 from the image data of the imaging device 11 by performing image processing such as edge detection processing with respect to the image data of the imaging device 11, so as to extract a feature amount of the image data of the imaging device 11. Further, in the memory 131b of the determinator 131, collation image data Im of a non-defective work (non-defective product), shown in FIG. 4 for example, is registered in advance. As shown in FIG. 4, the collation image data Im is the image data of the workpiece 20 in which a plurality of parts P1 to P3 are combined and assembled. The regions A1, A2, A3 shown by the broken line in the collation image data Im in FIG. 4 indicate assembling positions of the parts P1, P2, P3 on the workpiece 20. The determinator 131 determines whether or not the feature amount of the received and acquired image data of the workpiece 20 matches the feature amount of the collation image data Im, and determines whether or not the collation between the acquired image data of the workpiece 20 and the collation image data Im is established. When the feature amount of the acquired image data of the workpiece 20 matches the feature amount of the collation image data Im, the determinator 131 determines that the collation between the acquired image data of the workpiece 20 and the collation image data Im is established. In this case, the determinator 131 determines that the workpiece 20 is a good product (non-defective product). In the present embodiment, the process of comparing the feature amount of the acquired image data of the workpiece 20 with the feature amount of the collation image data Im corresponds to a process of collating the acquired image data of an inspection object to be inspected with the collation image data registered in advance.

The collation image data Im stored in the memory 131b includes reference image data and related image data. The reference image data is image data obtained by preliminarily photographing the workpiece 20 after assembling the predetermined parts P1 to P3 to the workpiece 20 in the work process of the worker H. The related image data is one or more image data similar to the reference image data. The related image data includes, for example, image data whose brightness is slightly different from that of the reference image data, image data whose imaging direction is slightly different from that of the reference image data, or the like. By using not only the reference image data but also the related image data as the collation image data Im, it is possible to collate the image data of the imaging device 11 and the collation image data Im even if there is some variation in the imaging environment of the imaging device 11.

The determinator 131 may execute the determination process of step S202 shown in FIG. 3 each time the image data is transmitted from the imaging device 11, or execute the determination process of step S202 at a predetermined cycle.

While the worker H assembling a predetermined part to the workpiece 20 after the workpiece 20 is carried to the worker's place by the conveyor 30, collation between the image data of the imaging device 11 and the collation image data Im is not established. Further, when the workpiece 20 is not included in the imaging range of the imaging device 11, collation between the image data captured by the imaging device 11 and the collation image data Im is not established. In this case, the determinator 131 makes a negative determination in the process of step S202, that is, determines that the workpiece 20 is not a non-defective product, and then determines whether a predetermined time elapses from the time when it is once determined that the workpiece 20 is not a non-defective product. The determinator 131 returns to the process of step S201 when a negative determination is made in the process of step S204, that is, when a predetermined time has not elapsed from the time where it is once determined that the workpiece 20 is not a non-defective product. In this case, the determinator 131 reacquires the image data of the imaging device 11 in the process of step S201, and determines again whether or not the workpiece 20 is a non-defective product in the process of step S202.

After that, when the assembly of the parts P1 to P3 to the positions A1 to A3 of the workpiece 20 is completed, the collation between the image data of the imaging device 11 and the collation image data Im is established. Thus, the determinator 131 makes the positive determination in the process of step S202, that is, determines that the workpiece 20 is a non-defective product, and causes the speaker 132 to output the first sound indicating that the workpiece 20 is a non-defective product in the process of step S203. Based on the first sound output from the speaker 132, the worker H can know that his/her work has been properly completed.

In contrast, for example, when the assembly positions of the parts P1 to P3 with respect to the workpiece 20 are incorrect, the collation between the image data of the imaging device 11 and the collation image data Im is not established. If this state continues for a predetermined time, the determinator 131 makes the positive determination in the process of step S204, and causes the speaker 132 to output the second sound indicating that the workpiece 20 is a defective product in the process of step S205. Based on the second sound output from the speaker 132, the worker H can know that the workpiece 20 is a defective product.

According to the inspection device 10 of this embodiment described above, operations and effects described in the following (i) to (iv) can be obtained.

(i) The imaging device 11 constantly images the imaging range and sequentially transmits the captured image data to the determinator 131. The determinator 131 determines the quality of the workpiece 20 by collating the image data of the workpiece 20 with the collation image data Im. The image data of the workpiece 20 can be acquired from the image data of the imaging device 11. According to this configuration, the quality of the workpiece 20 can be determined by the determinator 131 based on the image data constantly captured by the imaging device 11. Thus, in the present embodiment, it is unnecessary to have an operation that triggers the imaging of the workpiece 20 or an operation to start collation of the workpiece 20. Therefore, workability of the inspection device can be improved.

(ii) The determinator 131 collates the image data of the imaging device 11 with the collation image data Im each time the image data is transmitted from the imaging device 11 or at a predetermined cycle. According to this configuration, the quality determination of the workpiece 20 can be continuously executed.

(iii) The determinator 131 is provided with, as the collation image data Im, the reference image data corresponding to the non-defective product of the workpiece 20, and one or a plurality of related image data similar to the reference image data. According to this configuration, it is possible to accurately determine the quality of the workpiece 20 even when the imaging environment of the imaging device 11 varies.

(iv) The determinator 131 determines that the workpiece 20 is a defective product based on the determination that the state in which the workpiece 20 is determined to be not a non-defective product continues for a predetermined time. According to this configuration, it is possible to determine whether or not the workpiece 20 is a defective product without preparing image data corresponding to the defective product.

### Second Embodiment

Next, an inspection device 10 of the second embodiment will be described. Hereinafter, differences from the inspection device 10 of the first embodiment will be mainly described.

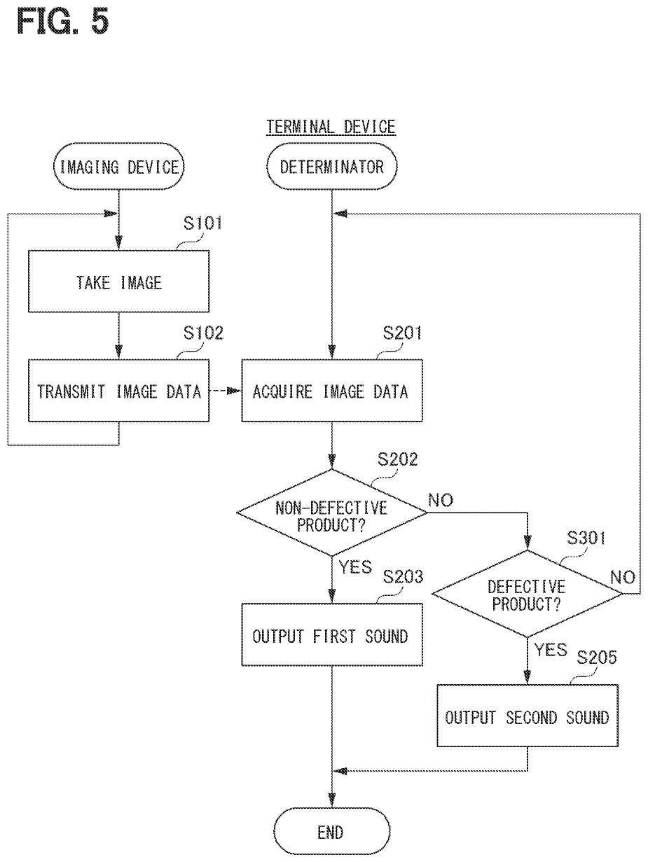

The imaging device 11 and the determinator 131 of the terminal device 13 of the present embodiment executes the process shown in FIG. 5 instead of the process shown in FIG. 3. In the process shown in FIG. 5, the same process as that shown in FIG. 3 is designated by the same reference numerals, and redundant description is omitted.

As shown in FIG. 5, when a negative determination is made in the determination process of step S202, the determinator 131 of the terminal device 13 further determines whether or not the workpiece 20 is a defective product in the subsequent process of step S301. The memory 131b of the determinator 131 stores not only the collation image data corresponding to the non-defective work (non-defective product) but also a plurality of collation image data corresponding to the defective work (defective product). The determinator 131 determines whether or not the workpiece 20 is a defective product based on whether or not the collation between the image data of the imaging device 11 and the collation image data of the defective work is established. In the process of step S301, a determination of a defective work is performed just by only changing the determination of non-defective work of step S202, the details of the process will be omitted.

After the workpiece 20 is carried to the worker's place by the conveyor 30, while the worker H assembling a predetermined part to the workpiece 20, the image data of the imaging device 11 and the collation image data of a defective work are made not to be collated. Further, when the workpiece 20 is not included in the imaging range of the imaging device 11, the image data captured by the imaging device 11 and the collation image data of the defective work are made not to be collated. In this case, the determinator 131 makes a negative determination in the process of step S301, and returns to the process of step S201.

In contrast, for example, when the assembly positions of the parts P1 to P3 with respect to the workpiece 20 are incorrect, the collation between the image data of the imaging device 11 and the collation image data of the defective work is established. In this case, the determinator 131 makes a positive determination in the process of step S301, and performs the process of step S205.

According to the inspection device 10 of the present embodiments described above, in addition to the functions and advantages shown in the above items (i) and (iii), the functions and advantages shown in the following item (v) can be obtained.

(v) The determinator 131 has collation image data corresponding to the non-defective work (non-defective product) and collation image data corresponding to the defective work (defective product) as the collation image data. The determinator 131 determines that the workpiece 20 is a non-defective product based on that the collation between the image data of the imaging device 11 and the collation image data of the non-defective work is established. The determinator 131 further determines that the workpiece 20 is a defective product in accordance with that the collation between the image data of the imaging device 11 and the collation image data of the defective work is established. Even in this configuration, it is possible to accurately determine the quality of the workpiece 20.

### Third Embodiment

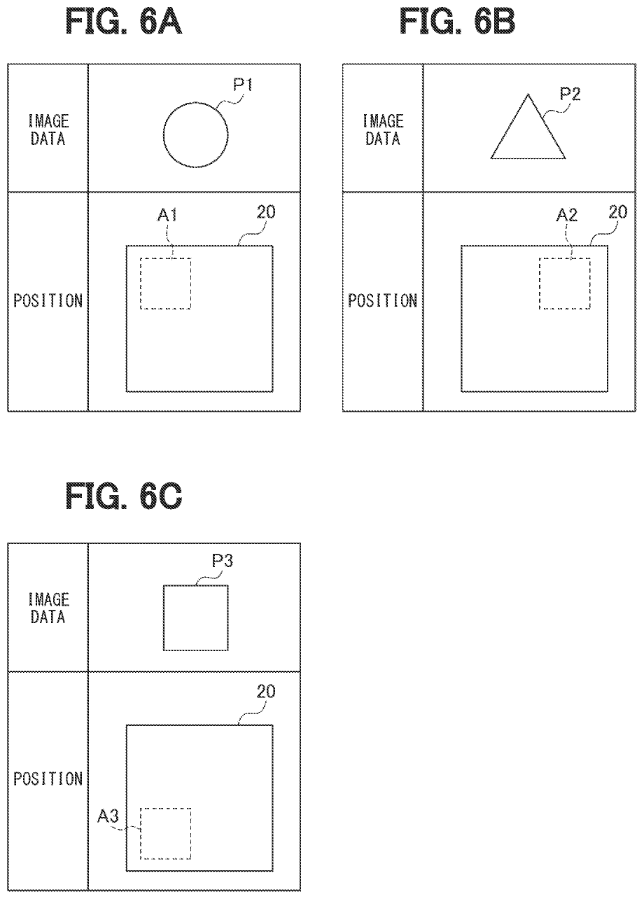

Next, an inspection device 10 of the third embodiment will be described with reference to FIGS. 6A to 6C in connection with FIG. 3. Hereinafter, differences from the inspection device 10 of the first embodiment will be mainly described.

The memory 131b of the determinator 131 of the present embodiment stores three non-defective product image data Im11 to Im13 shown respectively in FIGS. 6A to 6C as collation image data Im. The first non-defective product image data Im11 shown in FIG. 6A includes information of the image data of a part P1 and information of the assembly position A1 of the part P1 in the workpiece 20. The second non-defective product image data Im12 shown in FIG. 6B includes information of the image data of a part P2 and information of the assembly position A2 of the part P2 in the workpiece 20. The third non-defective product image data Im13 shown in FIG. 6C includes information of the image data of a part P3 and information of the assembly position A3 of the part P3 in the workpiece 20. The above-mentioned reference image data and related image data are prepared in advance in the image data information of each part P1 to P3.

In the process of step S202 shown in FIG. 3, the determinator 131 sets the first non-defective product image data Im11 of FIG. 6A as the collation image data Im. When the image data of the workpiece 20 is acquired from the image data of the imaging device 11, the determinator 131 determines whether or not the image data of the part P1 exists at the position A1 of the acquired image data. When the determinator 131 determines that the image data of the part P1 exists at the position A1 of the acquired image data of the workpiece 20, the second non-defective product image data Im12 shown in FIG. 6B is set as the collation image data Im. Next, the determinator 131 acquires the image data of the workpiece 20 from the image data of the imaging device 11, and determines whether or not the image data of the part P2 exists at the position A2 of the acquired image data. When the determinator 131 determines that the image data of the part P2 exists at the position A2 of the acquired image data of the workpiece 20, the third non-defective product image data Im13 shown in FIG. 6C is set as the collation image data Im. Next, the determinator 131 acquires the image data of the workpiece 20 from the image data of the imaging device 11, and determines whether or not the image data of the part P3 exists at the position A3 of the acquired image data. When the determinator 131 determines that the image data of the part P3 exists at the position A3 of the acquired image data of the workpiece 20, the determinator 131 determines that the workpiece 20 is a non-defective product.

In accordance with the part P1, the part P2, and the part P3 assembled to the workpiece 20 in this order, the determinator 131 determines whether or not the workpiece 20 is a non-defective product. When the determinator 131 determines that the workpiece 20 is a non-defective product, the first sound is output from the speaker 132.

On the other hand, for example, when the worker H assembles the part P1 to the workpiece 20 and then assembles the part P3, it is determined that the workpiece 20 is a non-defective product. In this case, when a predetermined time elapses from the time at which the workpiece 20 is once determined not to be a non-defective product, a second sound indicating that the workpiece 20 is a defective product is output from the speaker 132.

According to the inspection device 10 of this embodiment described above, operations and effects described in the following (vi) can be further obtained in addition to the above (i) to (iii) of the first embodiment.

(vi) The determinator 131 is provided with a plurality of non-defective product image data Im11 to Im13 different from each other as the collation image data Im, and determines that the workpiece 20 is a non-defective product when the image data of the imaging device 11 respectively corresponds to the plurality of non-defective product image data Im11 to Im13 in a predetermined order. If not only the positions of the parts P1 to P3 with respect to the workpiece 20 but also the assembly order of the parts P1 to P3 do not match with each other, the workpiece 20 is not determined to be a non-defective product. That is, when the positions of the parts P1 to P3 with respect to the workpiece 20 and the assembly order of the parts P1 to P3 match respectively the predetermined positions and predetermined order, the workpiece 20 is determined to be a non-defective product. Therefore, the inspection device 10 of the present embodiment is useful in the manufacturing process in which the assembly order of the parts P1 to P3 is also an inspection target.

### Other Embodiments

The embodiments described above can be also implemented in the following forms.

In the inspection device 10 of the third embodiment, the assembly order of the parts P1 to P3 is the inspection object, but only the assembly positions of the parts P1 to P3 may be the inspection object. For example, the determinator 131 acquires the image data of the workpiece 20 from the image data of the imaging device 11, and determines whether the acquired image data of the workpiece 20 includes all of the non-defective product image data Im21 to Im23 shown in FIGS. 6A to 6C in any order. Based on the determination that all of the non-defective product image data Im21 to Im23 exist in any order in the acquired image data of the workpiece 20, it is determined that the workpiece 20 is a non-defective product. Such the inspection device 10 can be useful in a manufacturing process in which the assembly order of the parts P1 to P3 is not an inspection target.

When the determinator 131 receives the image data transmitted from the imaging device 11 in the process of step S201 shown in FIG. 3, the determinator 131 may perform image processing to reduce the amount of information in the image data, and then may perform non-defective product determination shown in FIG. 3. As the process of reducing the amount of information in the image data, for example, trimming, compression, or a process of extracting only the shape data can be used. By performing the process of reducing the amount of information in the image data in this way, the repeated inspection can be speeded up, and the determination speed of the non-defective product determination can be improved.

The present disclosure is not limited to the specific examples described above. The specific examples described above which have been appropriately modified in design by those skilled in the art are also encompassed in the scope of the present disclosure so far as the modified specific examples have the features of the present disclosure. Each element included in each of the specific examples described above, and the placement, condition, shape, and the like of the element are not limited to those illustrated, and can be modified as appropriate. Each element included in each of the specific examples described above can be appropriately combined together as long as there is no technical contradiction.

What is claimed is:

1. An inspection device used for inspecting an inspection object to be inspected, the inspection device comprising:
an imaging device attached to an operator to image an imaging range; and
a determinator configured to determine whether or not a quality of the inspection object is defective, wherein
the imaging device is configured to constantly image the imaging range and to sequentially transmit image data of the imaging range to the determinator, and
the determinator determines the quality of the inspection object by collating an acquired image data of the inspection object, acquired from the image data transmitted from the imaging device, with a collation image data registered in advance.

2. The inspection device according to claim 1, wherein
the determinator is configured to collate the image data of the imaging device with the collation image data each time the image data is transmitted from the imaging device or at a predetermined cycle.

3. The inspection device according to claim 1, wherein
the determinator is configured to include a plurality of non-defective product image data different from each other as the collation image data, and to determine that the inspection object is a non-defective product when the image data transmitted from the imaging device respectively collate a plurality of non-defective product image data in a predetermined order.

4. The inspection device according to claim 1, wherein
the determinator is configured to include, as the collation image data, reference image data corresponding to a non-defective product of the inspection object and one or a plurality of related image data similar to the reference image data.

5. The inspection device according to claim 1, wherein
the determinator is configured to determine that the inspection object is a defective product when a state in which the inspection object is determined not to be a non-defective product continues for a predetermined time.

6. The inspection device according to claim 1, wherein
the determinator is configured
to include collation image data corresponding to a non-defective product and collation image data corresponding to a defective product, as the collation image data,
to determine that the inspection object is a non-defective product based on that collation between the image data of the imaging device and the collation image data corresponding to the non-defective product is established, and
to determine that the inspection object is a defective product based on that collation between the image data of the imaging device and the collation image data corresponding to the defective product is established.
